(19) United States
(12) Patent Application Publication
(10) Pub. No.: US 2014/0162787 A1
(43) Pub. Date: Jun. 12, 2014

(54) Tournament Gaming System and Method with a Bulk Reader

(71) Applicant: Multimedia Games, Inc., Austin, TX (US)

(72) Inventors: John J. Carpenter, Austin, TX (US); Keith Riggs, Austin, TX (US); Bradley W. Johnson, Austin, TX (US)

(21) Appl. No.: 14/040,432

(22) Filed: Sep. 27, 2013

Related U.S. Application Data
(60) Provisional application No. 61/707,599, filed on Sep. 28, 2012.

(51) Int. Cl. G07F 17/32

(52) U.S. Cl. CPC G07F 17/3276
USPC 463/42

(57) ABSTRACT

A tournament gaming system includes a control center and user interface connected to operate a tournament program with menu-driven selectable parameters enabling a user to program, initiate, and operate one or more tournaments in a gaming system. The user interface further includes a bulk data reader for populating a tournament player database and/or enrolling players in one or more tournaments.

### CROSS-REFERENCE TO RELATED APPLICATIONS

The application claims the benefit, under 35 U.S.C. §119(e), of U.S. Provisional Patent Application No. 61/707,599 filed Sep. 28, 2012, and entitled “Tournament Gaming System and Method with a Bulk Reader.” The entire content of this provisional patent application is incorporated herein by this reference.

This application also incorporates by this reference the entire content of each of the following applications: U.S. patent application Ser. No. 13/239,171 filed Sep. 21, 2011, entitled “Tournament Game, Gaming Machine, Gaming System and Method with a Player-Interactive Bonus Feature;” U.S. patent application Ser. No. 13/241,043 filed Sep. 22, 2011, entitled “Convertible In-Revenue and Out-Of-Revenue Gaming System and Method with a Real-Time Streaming Video Feed and Display;” U.S. patent application Ser. No. 13/232,900 filed Sep. 14, 2011, entitled Convertible In-Revenue and Out-Of-Revenue Gaming System and Method with a Real-Time Player Dashboard Display;” U.S. patent application Ser. No. 13/240,920 filed Sep. 22, 2011, entitled Tournament Game, Gaming Machine, Gaming System and Method with a Player Interactive Bonus Feature;” U.S. patent application Ser. No. 13/243,854 filed Sep. 23, 2011, entitled Wagering Game Method, Gaming Machine, Gaming System, and Program Product Facilitating Tournament Play;” U.S. patent application Ser. No.13/601,701 filed Aug. 31, 2012, entitled Wagering Game Method, Gaming Machine, Gaming System, and Program Product Providing an Enhanced Tournament Award Feature; and U.S. patent application Ser. No. 13/622,301 filed Sep. 18, 2012, entitled Tournament Game, Gaming Machine, Gaming System and Method with Team Management.”

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent files or records, but otherwise reserves all rights of copyright whatsoever.

### TECHNICAL FIELD OF THE INVENTION

This invention relates to wagering games, gaming machines, gaming systems, and associated methods. More particularly, the invention relates to a tournament gaming system and related methods including a bulk reader.

### BACKGROUND OF THE INVENTION

Various gaming systems have been developed to provide tournament gaming systems and methods.

There continues to be a need for innovative methods and tournament gaming systems which provide ease in the programming and operation of tournaments.

### SUMMARY OF THE INVENTION

In accordance with one or more embodiments of the present invention, a tournament gaming system includes a control center and user interface connected to operate a tournament program with menu-driven selectable parameters enabling a user to program, initiate, and operate one or more tournaments. The user interface further includes a bulk data reader for populating a tournament player database and/or enrolling players in one or more tournaments.

In some embodiments, a method of operating a tournament gaming system includes displaying a menu of tournament parameters selectable by an operator to program a tournament. The menu of tournament parameters may be displayed at a display device of a user console which serves as a user interface for the control center. Methods according to the invention may also include, responsive to an import request received through the user console, saving a set of tournament player information in a tournament database. The set of tournament player information may be read from a bulk data reader included in the user console or elsewhere in the system. Methods according to the present invention may also include searching the tournament database for stored data matching data read from a player card. Such a search may be conducted responsive to reading the data from the player card through a player card reader included in the tournament gaming system, perhaps at the user console. Responsive to finding stored data corresponding to the data read from the player card, a player associated with that player card may be enrolled into the tournament. Play in the tournament may be initiated responsive to a tournament play request, and such a request may be entered through the user console. It will be appreciated that the processes of displaying material, saving the set of tournament player information, searching the tournament database, enrolling a player into the tournament, and initiating play in the tournament may all be performed under control of the one or more processors included in the tournament gaming system.

These and other advantages and features of the invention will be apparent from the following description of illustrative embodiments, considered along with the accompanying drawings.

### BRIEF DESCRIPTION OF THE DRAWINGS

FIG. 1A illustrates an example tournament gaming system shown with a control center controlling a bank of gaming machines with respective game themes, such as during a tournament operating mode, in accordance with one or more embodiments.

FIG. 1B is a diagrammatic representation of an example control center user console connected to the control center in accordance with one or more embodiments.

FIG. 2 illustrates an example tournament control screenshot displayable at a user console in accordance with one or more embodiments.

FIG. 3A illustrates an example Game Play selection of an edit tournament screenshot displayable at a user console in accordance with one or more embodiments.

FIG. 3B illustrates an example Advancement Type selection of an edit tournament screenshot displayable at a user console in accordance with one or more embodiments.

FIG. 3C illustrates an example Scoring Type selection of an edit tournament screenshot displayable at a user console in accordance with one or more embodiments.

FIG. 3D illustrates an example Session Ranking selection of an edit tournament screenshot displayable at a user console in accordance with one or more embodiments.

FIG. 3E illustrates an example Rounds selection of an edit tournament screenshot displayable at a user console in accordance with one or more embodiments.

FIG. 3F illustrates an example Tournament Prizes selection of an edit tournament screenshot displayable at a user console in accordance with one or more embodiments.

FIG. 3G illustrates an example Session Prizes selection of an edit tournament screenshot displayable at a user console in accordance with one or more embodiments.

FIG. 3H illustrates an example Playerstations selection of an edit tournament screenshot displayable at a user console in accordance with one or more embodiments.

FIG. 3I illustrates an example Configuration selection of an edit tournament screenshot displayable at a user console in accordance with one or more embodiments.

FIG. 4A illustrates an example Player Import screenshot displayable following a database upload at a user console in accordance with one or more embodiments.

FIG. 4B illustrates an example Player Import screenshot displayable following an import into either a player database or existing tournament at a user console in accordance with one or more embodiments.

FIG. 4C illustrates an example Tournament Control screenshot displayable, such as following an import operation, at a user console in accordance with one or more embodiments.

FIG. 4D illustrates an example Create Player screenshot displayable at a user console in accordance with one or more embodiments.

FIG. 4E illustrates an example Player Import screenshot displayable, such as after to sliding two player cards through a card reader, at a user console in accordance with one or more embodiments.

FIG. 4F illustrates an example Tournament Control screenshot displayable, such as following a player import operation from the screenshot of FIG. 4E, at a user console in accordance with one or more embodiments.

FIG. 4G illustrates an example Tournament Control screenshot displayable, such as following one or more additional import operations, at a user console in accordance with one or more embodiments.

FIG. 4H illustrates an example Playerstations Assignments screenshot displayable at a user console in accordance with one or more embodiments.

FIG. 4I illustrates another example Playerstations Assignments screenshot displayable following a shuffle operation at a user console in accordance with one or more embodiments.

FIG. 4J illustrates an example Edit Profile screenshot displayable at a user console in accordance with one or more embodiments.

FIG. 4K illustrates an example Tournament Control screenshot displayable, such as following a player import operation, at a user console in accordance with one or more embodiments.

FIG. 4L illustrates an example Tournament Control screenshot displayable, such as following a player move operation subsequent to the screenshot of FIG. 4K, at a user console in accordance with one or more embodiments.

FIG. 4M illustrates an example Tournament Control screenshot displayable, such as following a tournament round to show the results, at a user console in accordance with one or more embodiments.

FIG. 4N illustrates an example Tournament Control screenshot displayable, such as following a tournament to show the final and round results, at a user console in accordance with one or more embodiments.

FIG. 4O illustrates an example Tournament Details screenshot displayable, such as following a tournament, at a user console in accordance with one or more embodiments.

FIG. 5A illustrates an example Quick Tournament screenshot displayable at a user console in accordance with one or more embodiments.

FIG. 5B illustrates an example Tournament Control screenshot displayable, such as following initiating a new tournament from the Quick Tournament screen, at a user console in accordance with one or more embodiments.

### DESCRIPTION OF ILLUSTRATIVE EMBODIMENTS

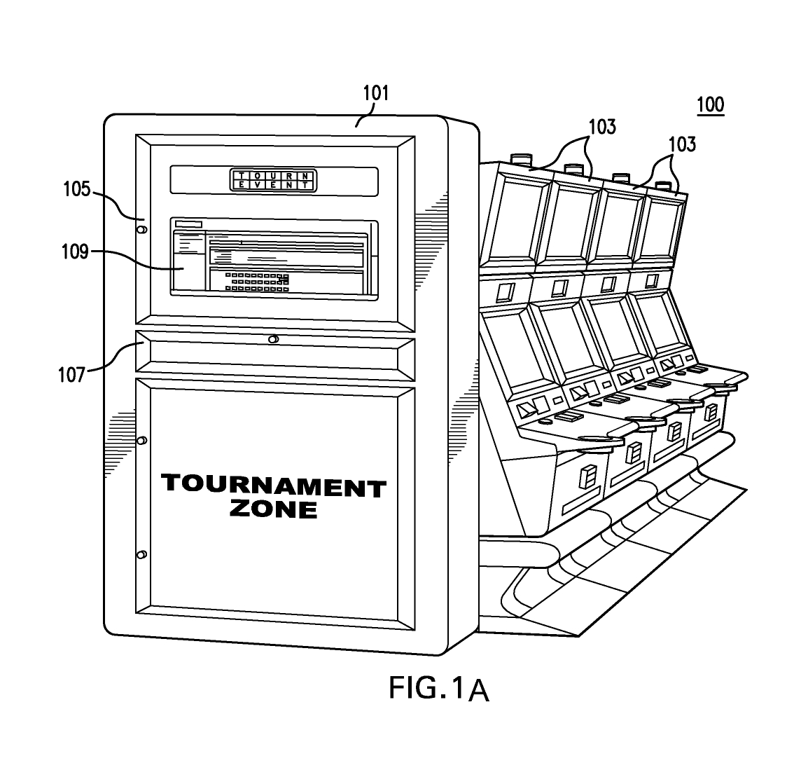

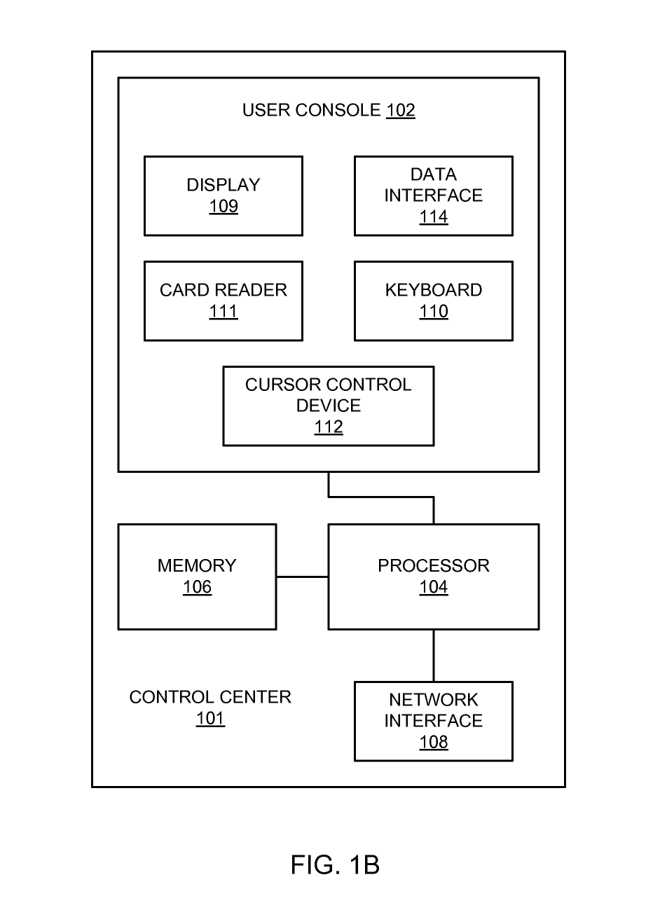

Referring to FIG. 1A, example server-based convertible in-revenue and out-of-revenue gaming system 100 is shown with control center 101 enabling remote functionality management of a number of gaming machines 103 (also referred to herein as playerstations), such as updating game configuration, uploading advertisements, administering tournaments, and converting in-revenue and out-of-revenue operation, in accordance with one or more embodiments and as is more fully described in the aforementioned applications which are incorporated by reference. Control center 101 includes a display 109 which is part of a user console for the control center. Further features of the user console will be discussed below in connection with FIG. 1B. Display 109 is visible through a window of door 105. Door 107 may be opened to provide user access (for example, casino operator access) to other features of the user console.

As shown in FIG. 1B, control center 101 includes a processor 104 which may be mounted on a conventional personal computer or server motherboard (not shown) having various interfaces and ports to support peripheral devices along with network interface 108 and memory 106. Memory 106 may include RAM to support processor 104 along with mass storage such as a hard drive, PROM, or CD ROM containing the programming enabling control center 101 to control in-revenue and out-of-revenue operating modes of gaming machines 103 and to support creation, editing, and storing of command, instruction, and data sets associated with in-revenue and/or out-of-revenue events. The installed software may include a Microsoft Windows® OS enabling menu driven document creation and editing to provide user-friendly document/program search or creation, editing, storage, and execution functionality within the limits of the user's authorization level. User authorization and access may be accommodated through an initial username and password entry screen. Once a user's authorization has been verified through matching with records stored on the server or network, a main menu may be displayed enabling a user to access, initiate or program out-of-revenue or in-revenue events.

Processor 104 may be programmed to implement several different controllers providing functions or services for the gaming machines 103 and associated equipment (such as an overhead display (not shown)). In particular, processor 104 may implement a tournament controller for controlling and facilitating the conversion of gaming machines 103 from individual in-revenue play to tournament play (either in-revenue or out-of-revenue) and back. During tournament play, the tournament controller communicates with the various gaming machines 103 participating in the tournament, maintains information on the conduct of the tournament, such as real-time standings and scores, and makes tournament information available to the gaming machines 103 or other system elements for display over the course of the tournament. In its operation as a tournament controller, processor 104 also controls the conversion of gaming machines 103 back from tournament play mode to individual play mode. Network interface 108 provides a suitable interface facilitating the necessary communications between control center 101 and the various gaming machines 103.

FIG. 1B also shows an example user console 102 associated with control server 101. The example user console 102 includes display 109, a keyboard 110, a card reader 111, a cursor control device 112 (such as a trackball or mouse), and a data interface 114. User console 102 may be used by an operator to set up and operate multiple tournaments and link and control one or more banks of gaming machines 103 by activating an executable tournament program installed and operable on a suitable processor, such as processor 104. As will be described further below in connection with a number of example user interface screens, display 109 may be controlled by processor 104 to provide various graphical interfaces which allow the operator to perform various tournament set up and operation functions, and to facilitate the enrollment of various players in the tournaments. Card reader 111 may be used to read information from player cards to facilitate adding players to a tournament database and enrolling players in tournaments as will be described in detail below. Data interface 114 may comprise a USB connector or other suitable connector or media reader to allow access to data stored in flash memory or another suitable memory device (not shown). Data interface 114 may represent a bulk reader which may be used to allow player database files to be imported into the tournament database of the tournament gaming system, and to facilitate the enrollment of players into various tournaments to be conducted through the tournament gaming system.

It should be appreciated that the diagrammatic representation of FIG. 1B is not intended to suggest any particular type of connection between processor 104 and the other elements shown in the figure. The line connecting processor 104 and user console 102 is shown only to indicate that the processor is connected in some fashion for communication with the various elements of the user console. Display 109 will typically employ some graphics interface to processor 104 and a suitable connector such as a cable suitable for the graphics interface. The other elements shown in user console 102 may connect to processor 104 through a suitable USB or other serial interface controller (not shown) associated with the processor and through appropriate cabling to such a controller. Connection details and options between the various elements of user console 102 are readily apparent to those of ordinary skill in the art and are thus not discussed further herein.

In some embodiments of the invention, user interface devices such as keyboard 110, card reader 111, cursor control device 112, and data interface 114 may be stored behind door 107 so as to be accessible only by opening that door. Keyboard 110 and cursor control device 112 may be mounted on a recessed slideable tray which, once door 107 is opened, slide outward approximately six to eight inches to accommodate user (such as a casino operator) access to the keyboard and cursor control device. Opening door 107 may also expose card reader 111 and data interface 114. Particularly where keyboard 110 is mounted on a slideable tray, door 107 may be hinged along its lower edge to allow the top of the door to pivot outwardly to an open position for the door and facilitate sliding the tray out to an operating position.

Control center 101 may be network connected to the one or more banks of gaming machines 103, one or more overhead displays (not shown), and kiosks (not shown), all via network interface 108 or other suitable interface. The kiosks may include a suitable card reader similar to card reader 111 which any player having a player card may use to read their player card to enter one or more tournaments. The kiosks may be situated in various convenient locations, such as on an operator's casino floor, hallways, bars, etc. The kiosks may have the same or a similar design and software and network connection as user console 102 with access limited to the players to enter their card information and request entry into one or more tournaments. Access to the further tournament program functionality may be limited to operators with a passcode.

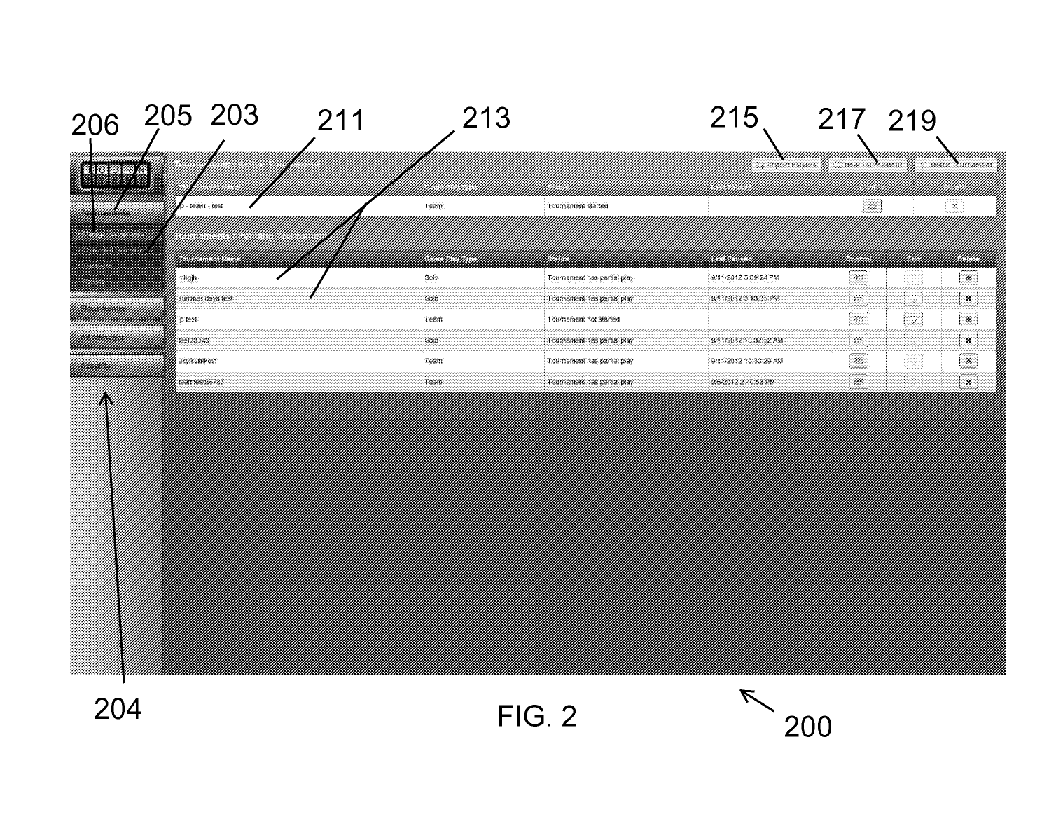

Referring to FIG. 2, example tournaments screen 200 is shown, which may, for example, be displayed at display 109 user console 102 after activating the tournament program in accordance with one or more embodiments. Tournaments screen 200 may be accessed by selecting from a menu shown generally at 204 in FIG. 2, and which may include “Tournaments” control 205 and other clickable menu topics (active fields or areas) to access various user interface screens. In the example screen, a drop-down menu 203 from “Tournaments” control 205 includes “Manage Tournaments” control 206 which is the first level of the tournaments menu 203. In tournaments screen 200, a listing is provided of “Active Tournaments” 211 including headers for “Tournament Name,” “Game Play Type” (solo or team), “Status” (e.g., started), “Last Paused,” “Control,” “Delete.” Each “Active Tournaments” 211 is displayed as a separate line item having a respective “Control” and “Delete” selectable icon. Similarly, a listing is provided of “Pending Tournaments” 213 each shown in a separate line item having the same headers used for the “Active Tournaments” 211 plus an “Edit” header and corresponding selectable edit icon with each line item 213. The “Control” icon enables a user to initiate the tournament mode for the corresponding tournament. The “Delete” icon may be selected only if a tournament session has not begun and may be selected to delete the tournament. The “Edit” icon may be selected only for pending tournaments which have not been started. Tournaments which have been started may be paused between sessions or rounds, but the “Edit” icon will be inactive. Pending tournaments, which have not been started or have been paused, may be deleted. Once a tournament is completed, its line item will be eliminated from tournaments screen 200.

Additional active elements are provided in the upper right corner of tournaments screen 200 which include “Import Players” 215, “New Tournament” 217, and “Quick Tournament” 219 selectable fields to respectively enable a user to access an import players screen and import players into a tournament, access a new tournament screen and program a new tournament, and access a quick tournament screen and access and initiate a saved tournament.

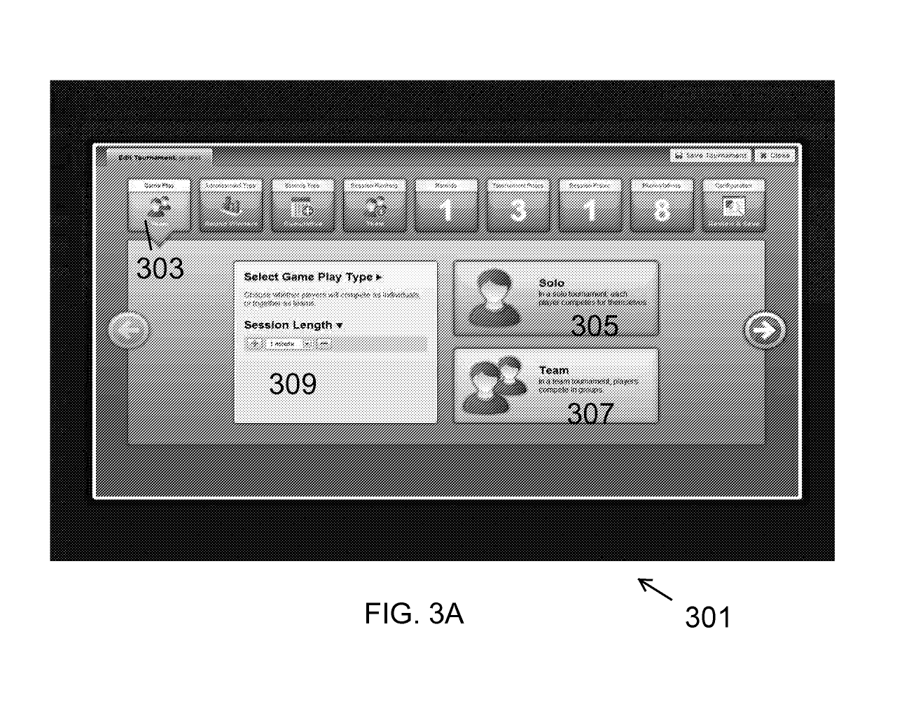

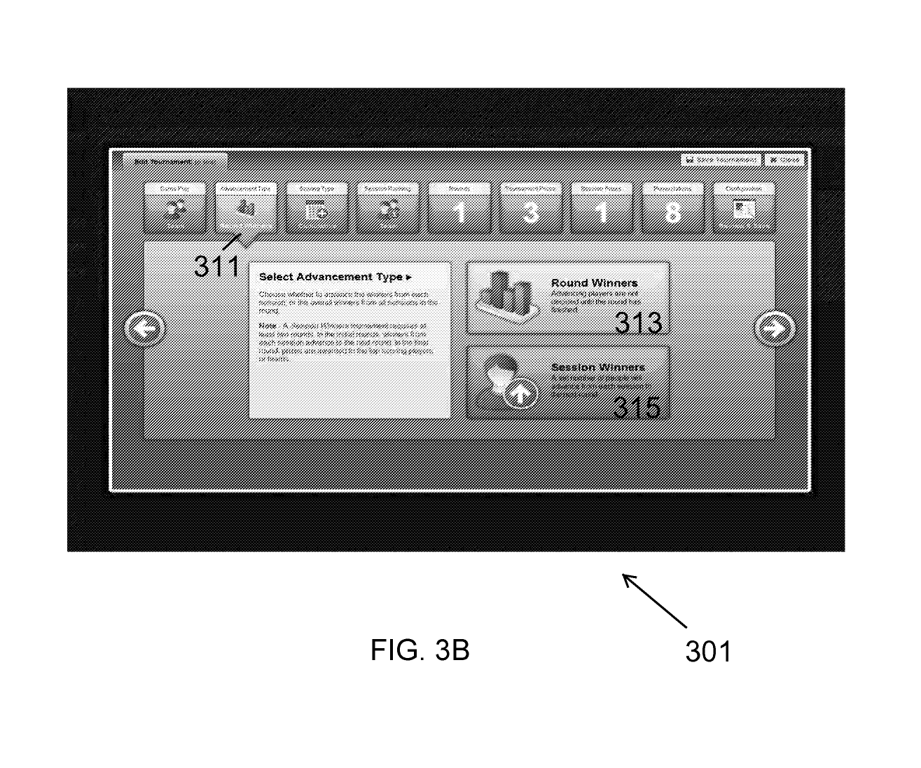

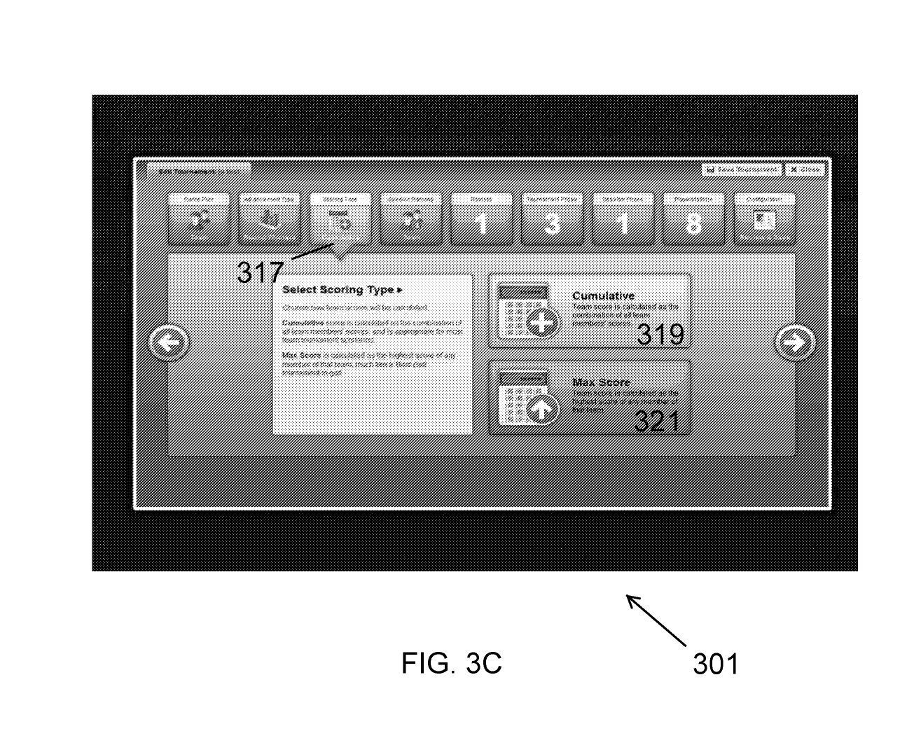

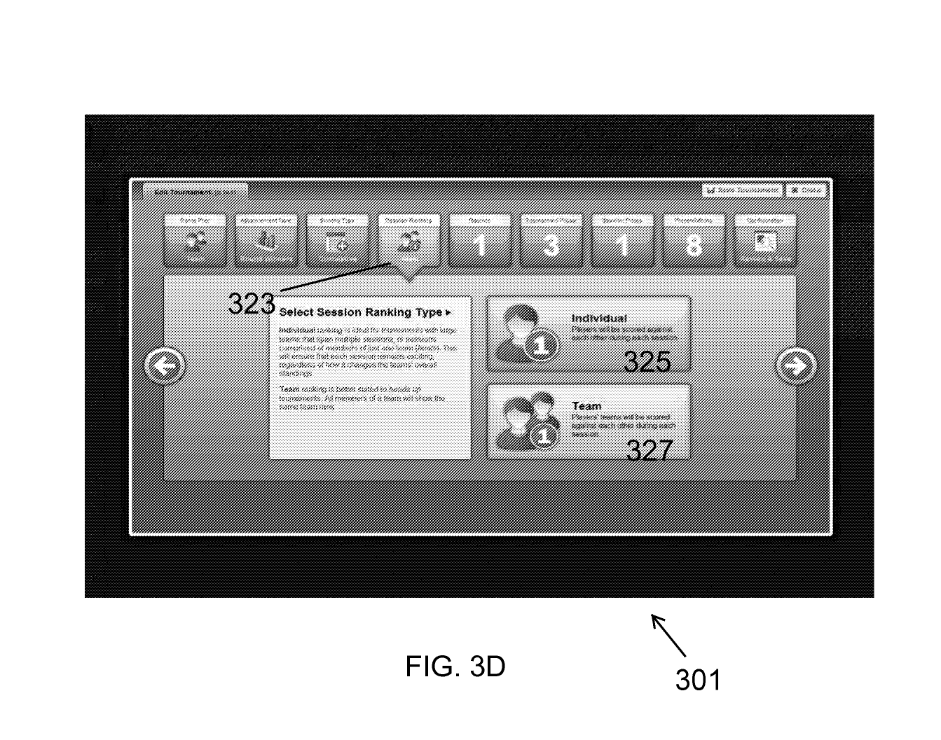

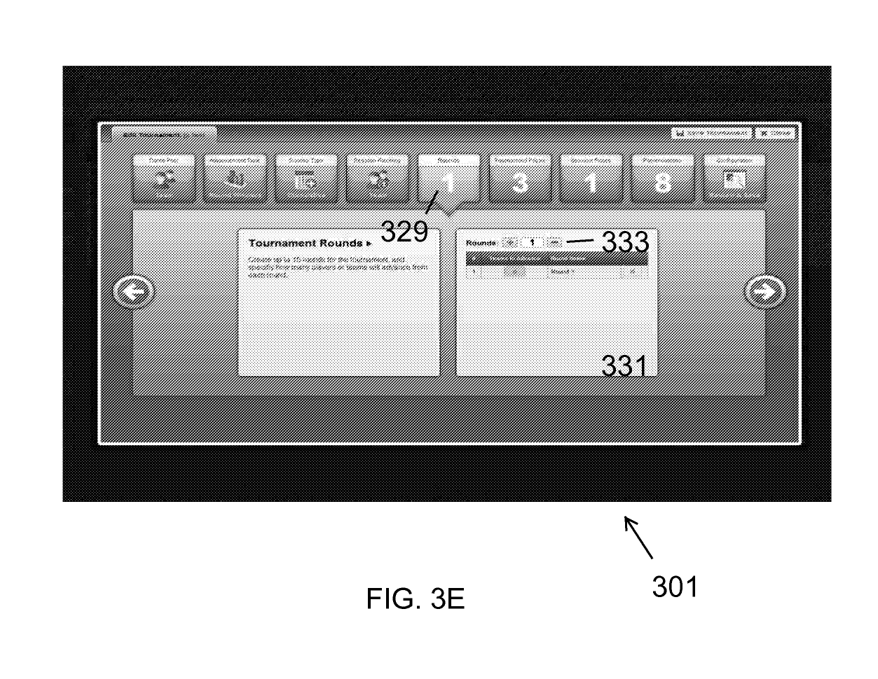

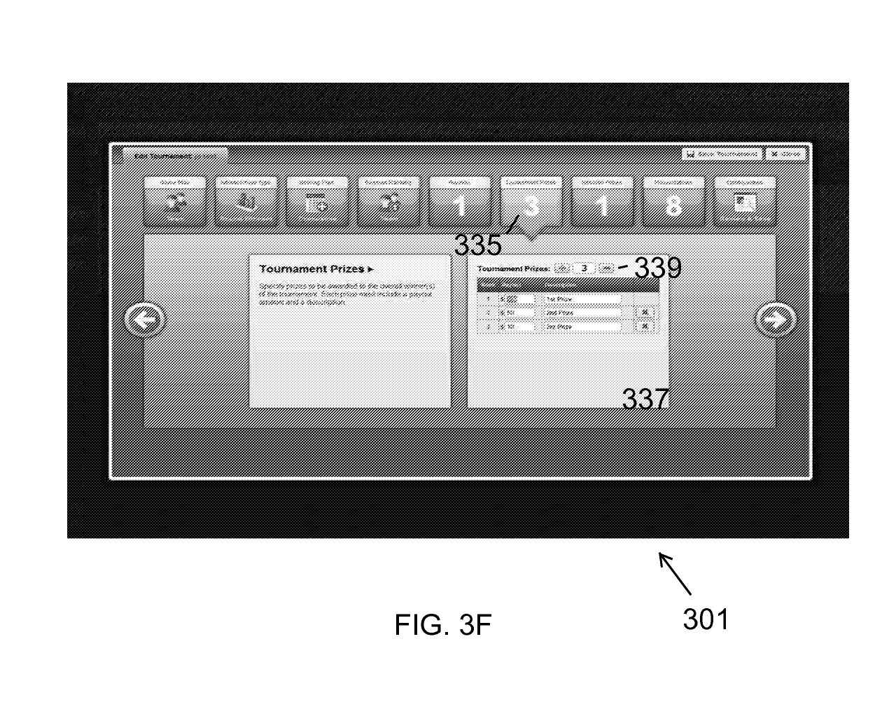

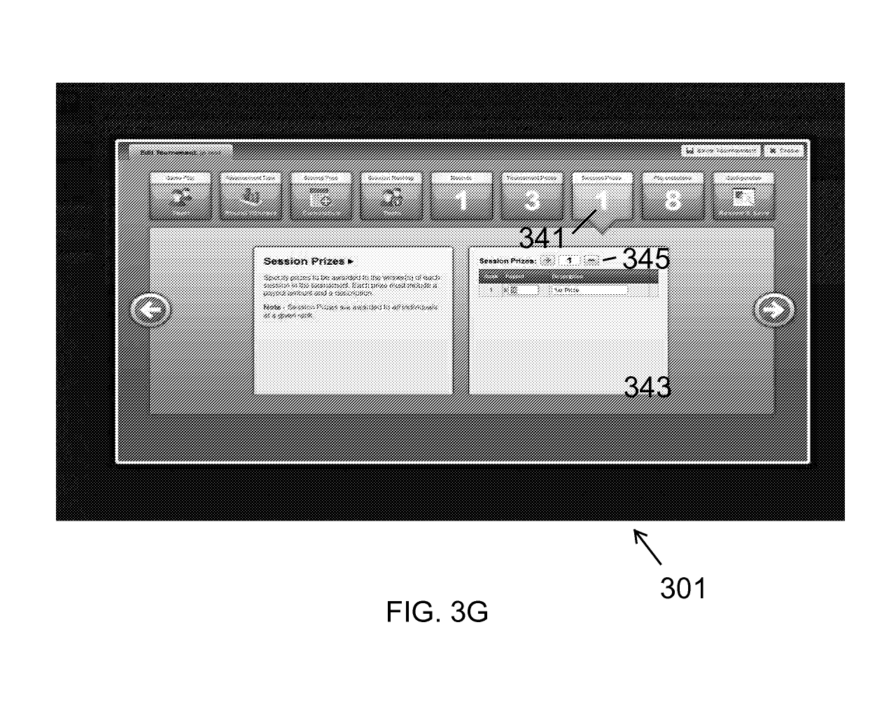

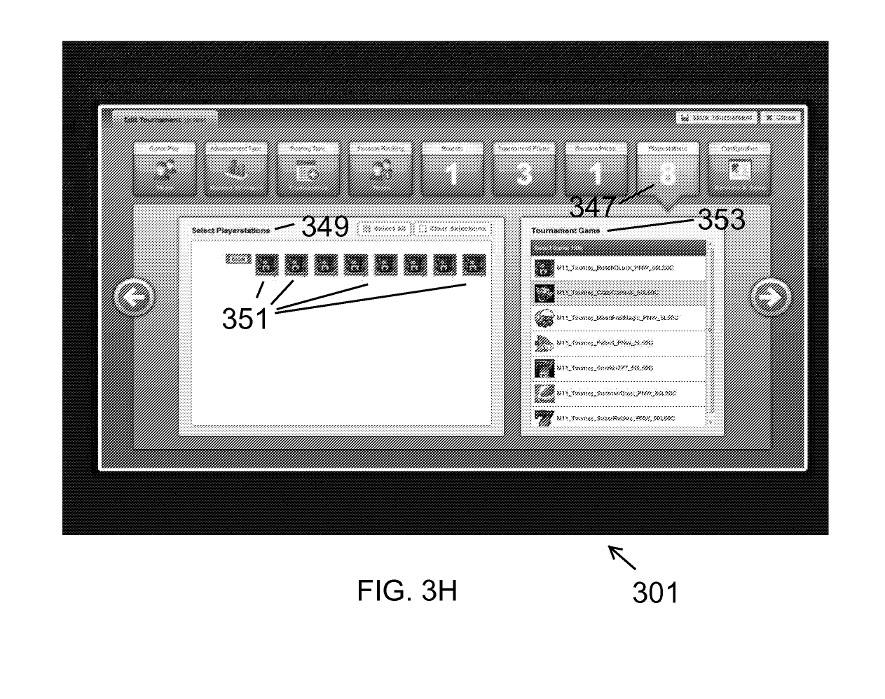

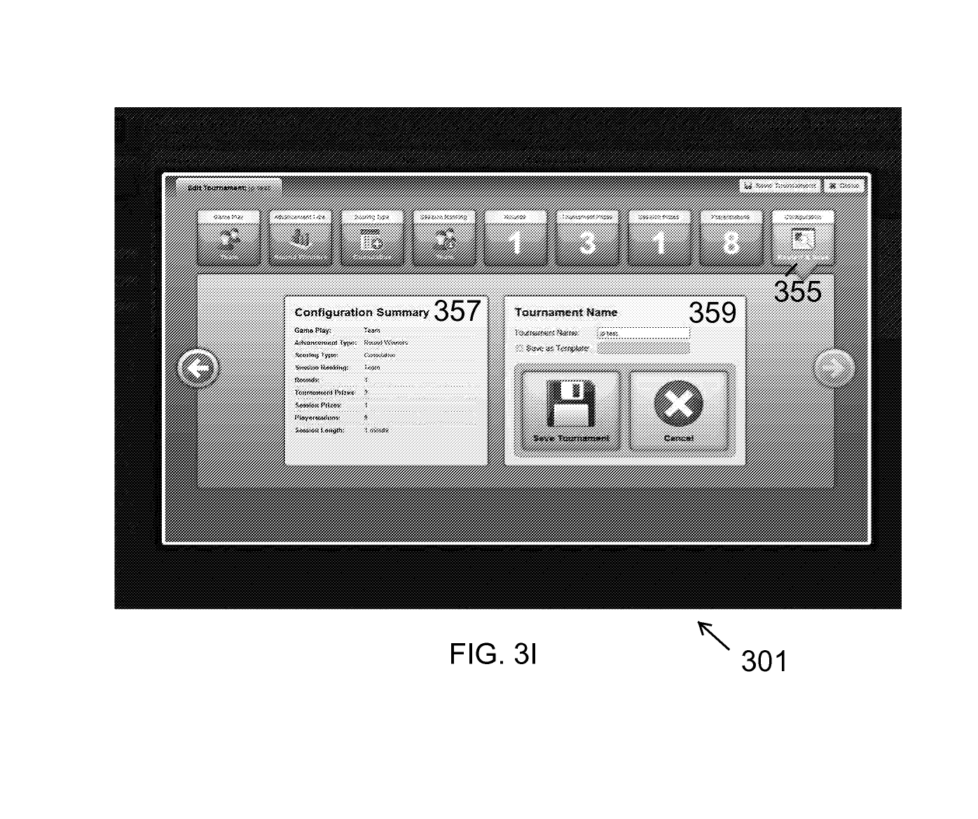

Referring to FIGS. 3A-3G each show an example of a tournament edit screen 301 is as may be displayed on display 109 (which may be a touch-sensitive display) of user console 102 when either the “Edit” icon or “New Tournament” field 217 (both shown in FIG. 2) are selected by a user, in accordance with one or more embodiments. In the example of FIGS. 3A-3G, one of the pending tournaments (listed in a line item 211 in FIG. 2) is selected for editing; however, the tournament edit screen 301 is essentially the same when activated through “New Tournament” field 217 in FIG. 2 except that a popup is provided for the user to input a tournament name.

Referring to FIG. 3A, the initial selectable element shown is the “Game Play” element 303 which when selected opens a selection display as to what type of tournament game play is to be selected—solo (individual) or teams and what will be the session length, in accordance with one or more embodiments. On the screen, there may be a selectable “Solo” element 305 and a selectable “Team” element 307, and, there may also be some explanatory language or a ‘help’ button to provide explanatory information to assist a user. If the user selects “Solo” element 305, then each competitor will compete for themselves against each of the other players in a given session or round; whereas, if the user selects the “Team” element 307 as shown in the example, players compete as members of respective teams against each of the other teams in a given session or round. When a game type is selected, the processor executing the tournament program causes the “Game Play” element 303 to be modified to include a team logo and a team legend as shown, or a solo logo and a solo legend, depending upon the user's selection. The “Game Play” element 303 may display a default Solo game play type, so that an individual play tournament is the default setting. In addition to the type of game play, the screen shown in FIG. 3A also includes a selectable “Session Length” element 309 which may include a time legend area that may include a drop down menu when selected to select from a range of times (e.g. 15, 30, 45 sec and 1, 2, 3, 4, 5, 6, 7, 8, 9, 10 minutes) and/or which may be incremented by an increment field (e.g. “+”) or decremented by a decrement field (e.g. “−”). The “Session Length” element 309 may display a default time, such as 1 minute.

Referring to FIG. 3B, the next selectable element shown is the “Advancement Type” element 311 which when selected opens a selection display as to what type of advancement format is to be selected, “Round Winners” or “Session Winners.” On the screen, there may be a selectable “Round Winners” element 313 and a selectable “Session Winners” element 315, and, may also be some explanatory language or a ‘help’ button to provide explanatory information to assist a user. If the user selects “Round Winners” element 313, then each competitor (individual or team, depending upon the Game Type element 303 selection) will compete with each of the other competitors in a given round as shown in the example, so that winning in a given session is non-determinative as to whether a competitor advances, instead the top scorer or scorers from all the sessions will be ranked collectively; whereas, if the user selects the “Session Winners” element 315, competitors compete against each of the other competitors in a given session to determine whether they advance to the next round, so that the top scorer or scorers in a given session will be determined to advance based on the settings (rules) of the tournament. When a game advancement type is selected, the processor executing the tournament program causes the “Advancement Type” element 311 to be modified to include either a round winners logo and a round winners legend as shown, or a session winners logo and a session winners legend, depending upon the user's selection. The “Advancement Type” element 311 may display a default “Session Winners” advancement type, so that each session's winner or winners advance according to the default setting.

Referring to FIG. 3C, the next selectable element shown is the “Scoring Type” element 317 which may be selected when “Team” play has been designated and when selected opens a selection display for what type of scoring format is to be selected, “Cumulative” or “Max Score.” The illustrated example select display in FIG. 3C includes a selectable “Cumulative” element 319 and a selectable “Max Score” element 321, and, may also include some explanatory language or a ‘help’ button to provide explanatory information to assist a user. If the user selects “Cumulative” element 319, then each player on the team contributes to the score of their team, so that the team or teams with the highest cumulative score or scores in a given session is determinative as to which team or teams advance; whereas, if the user selects the “Max Score” element 321, then the highest score of a player on a given team becomes the team's score and is used to determine whether the team advances to the next round based on their standing in the round or session, depending on the rules (settings) of the tournament. When a scoring type is selected, the processor executing the tournament program causes the “Scoring Type” element 317 to be modified to include either a cumulative logo and a cumulative legend as shown, or a max score logo and a max score legend, depending upon the user's selection. The “Scoring Type” element 317 may display a default “Cumulative” scoring type, so that each session's winner or winners by default are the teams with the highest cumulative scores and advance according to the default setting.

Referring to FIG. 3D, the next selectable element in example tournament edit screen 301 is the “Session Ranking” element 323 which may be selected when team play has been designated, and when selected, opens a selection display as to what type of ranking format is to be selected for each session, individual or team. The example selection display shown in FIG. 3D includes a selectable “Individual” element 325 and a selectable “Team” element 327, and, may also include some explanatory language or a ‘help’ button to provide explanatory information to assist a user. If the user selects “Individual” element 325, then each player regardless of their respective team competes with each of the other players during a given session, so that the player or players with the highest score or scores in a given session are ranked accordingly on the leaderboard for the session; whereas, if the user selects the “Team” element 327, then the teams cumulative scores will be used to rank the team for each session. When a session ranking type is selected, the processor executing the tournament program causes the “Session Ranking” element 323 to be modified to include either a team logo and a team legend as shown, or an individual logo and an individual legend, depending upon the user's selection. The “Session Ranking” element 323 may display a default Team ranking type, so that the teams with the highest scores are ranked accordingly on the leaderboard during each session.

FIG. 3E shows an example tournament rounds selection display 331 which is opened when the user selects the tournament rounds element 329 from tournament edit screen 301. The illustrated example a tournament rounds selection display 331 provides a selectable rounds element 333 enabling the user to select the number of rounds for play of the tournament. Additionally, there may also be some explanatory language or a ‘help’ button to provide explanatory information to assist a user. Rounds element 333 may include a rounds indicator area that may include a drop down menu when selected to select from a range of preset rounds (e.g. 1, 2, 3, 4, 5, 6, 7, 8, 9, 10 rounds) and/or may include an increment field (e.g. “+”) which may be invoked to increment the number of rounds and a decrement field (e.g. “−”) which may be invoked to decrement the number of rounds. The rounds element 333 may display a default number of rounds that are to be played in the tournament, e.g. 1. For each round selected, a drop down may display the round number, teams to advance from the round, round name (e.g. Round 1), and a selectable delete icon to remove the round.

FIG. 3F shows an example tournament prizes selection display 337 which is opened when the user selects the “Tournament Prizes” element 335. The tournament prizes selection display 337 provides a selectable “Prizes” element 339 enabling a user to select the number of prizes to award in the tournament. Additionally, there may also be some explanatory language or a ‘help’ button to provide explanatory information to assist a user. “Prizes” element 339 may include a prizes indicator area that may include a drop down menu when selected to select from a range of preset prizes (e.g. 1, 2, 3, 4, 5 prizes) and/or may include an increment field (e.g. “+”) which may be invoked to increment the number of rounds and a decrement field (e.g. “−”) which may be invoked to decrement the number of rounds. The “Prizes” element 339 may display a default number of prizes that are to be awarded in the tournament, e.g. 3. For each prize selected, a drop down may display the rank (e.g. 1), payout (e.g. $100), prize description (e.g. 1st Prize), and a selectable delete icon to remove prizes beyond first place.

Referring to FIG. 3G, the next selectable element shown is the “Session Prizes” element 341 which when selected opens a “Session Prizes” selection display 343 providing a selectable “Session Prizes” element 345 enabling the user to select the number of prizes to award in each session of the tournament. Additionally, there may also be some explanatory language or a ‘help’ button to provide explanatory information to assist a user. “Session Prizes” element 345 may include a prizes indicator area that may include a drop down menu when selected to select from a range of preset prizes (e.g. 1, 2, 3, 4, 5 prizes) and/or may include an increment field (e.g. “+”) which may be invoked to increment the number of rounds and a decrement field (e.g. “−”) which may be invoked to decrement the number of rounds. The “Session Prizes” element 345 may display a default number of prizes that are to be awarded in each session, e.g. 1. For each prize selected, a drop down may display the rank (e.g. 1), payout (e.g. $10), prize description (e.g. 1st Prize), and a selectable delete icon to remove prizes beyond first place.

Referring to FIG. 3H, the next selectable element shown is the “Playerstations” element 347 which when selected opens a playerstations selection display 349 providing a set of selectable playerstation icons 351, each such icon representing a respective one of the gaming machines 103 available in the tournament system. Playerstation icons 351 enable the user to select the number of playerstations to be used in each session of the tournament. Selecting “Playerstations” element 347 also opens a tournament game selection display 353 which includes a set of selectable tournament game icons enabling the user to select the tournament game to be played in each session of the tournament. Additionally, there may also be some explanatory language or a ‘help’ button to provide explanatory information to assist a user. The playerstations selection display 349 may display a default number of playerstations that are to be used in each session, e.g. 8, and tournament game selection display 353 may display a default game to be played in each session of the tournament. For ease of use, playerstations selection display 349 may include a “Select All” and “Clear Selections” button for selecting all the playerstations shown or clearing all the playerstations; alternatively, the user may select or de-select one or more playerstations by clicking individually on the respective playerstation icons to activate or de-activate the respective playerstations in the tournament.

FIG. 3I shows an example “Configuration Summary” display 357 which opens upon a user's selection of the “Configuration” element 355 in display 301. The “Configuration Summary” display 357 provides a listing of the selections for the tournament and allows the user to review the selections prior to saving the tournament with the tournament program. FIG. 3I also shows that selecting the “Configuration” element 355 also opens a “Tournament Name” selection display 359 which enables the user to enter a name for the tournament when to be saved in the system upon selection of the “Save Tournament” button shown in “Tournament Name” selection display 359. Additionally, there may also be some explanatory language or a ‘help’ button to provide explanatory information to assist a user. The “Tournament Name” selection display 359 may display a default name for the tournament; for example, if the user has edited an existing tournament, the edited tournament name may be displayed for saving or the user may change the name to save the edited tournament by a different name. Once a name is determined, the user may select the “Save Tournament” button to save the tournament or a “Cancel” button to cancel it; additionally, the user may save the tournament as a template by selecting a “Save as Template” checkbox prior to saving the tournament.

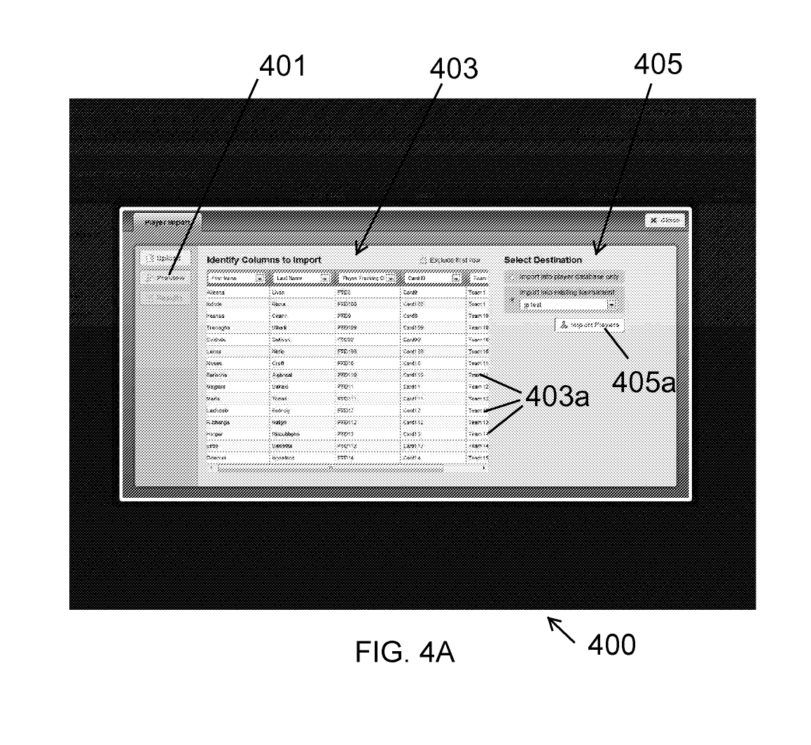

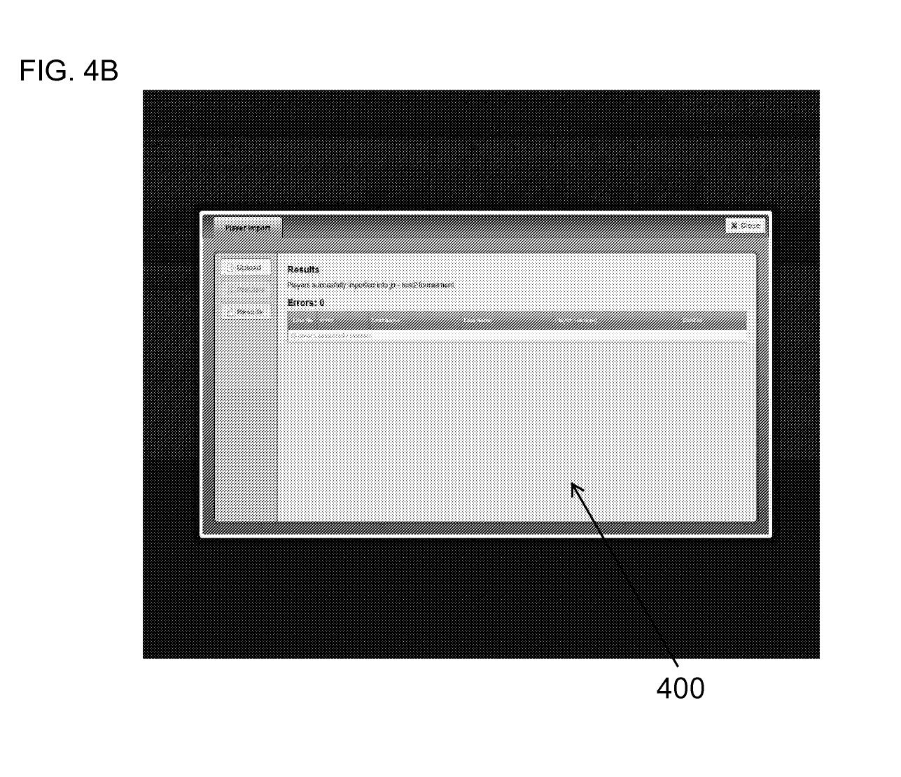

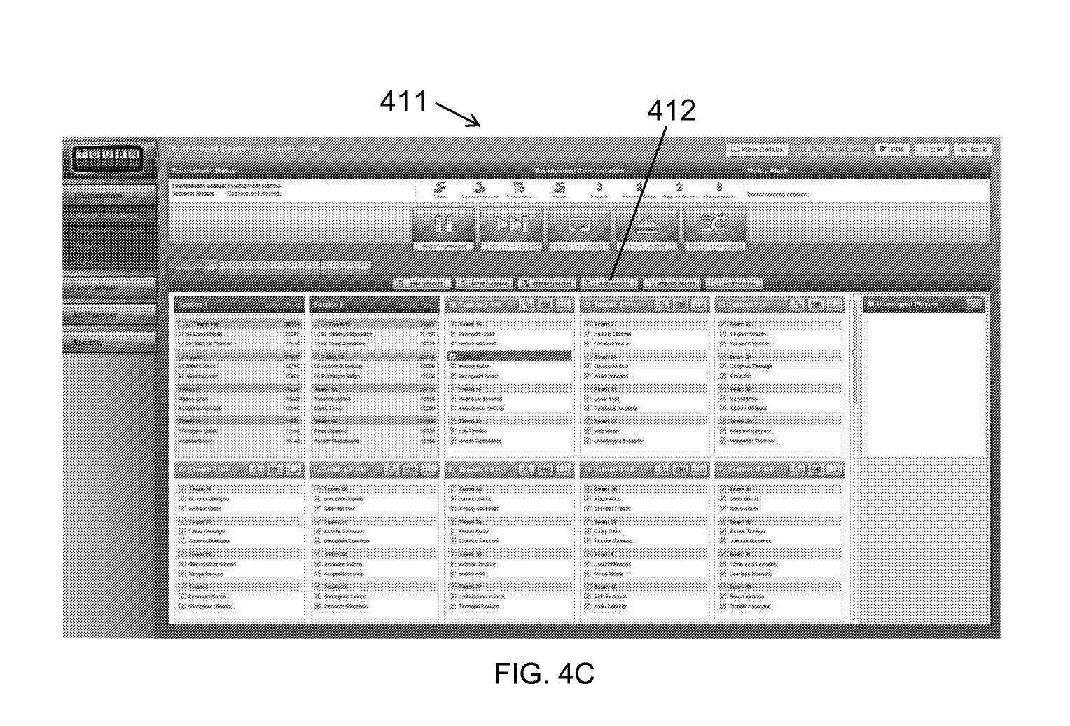

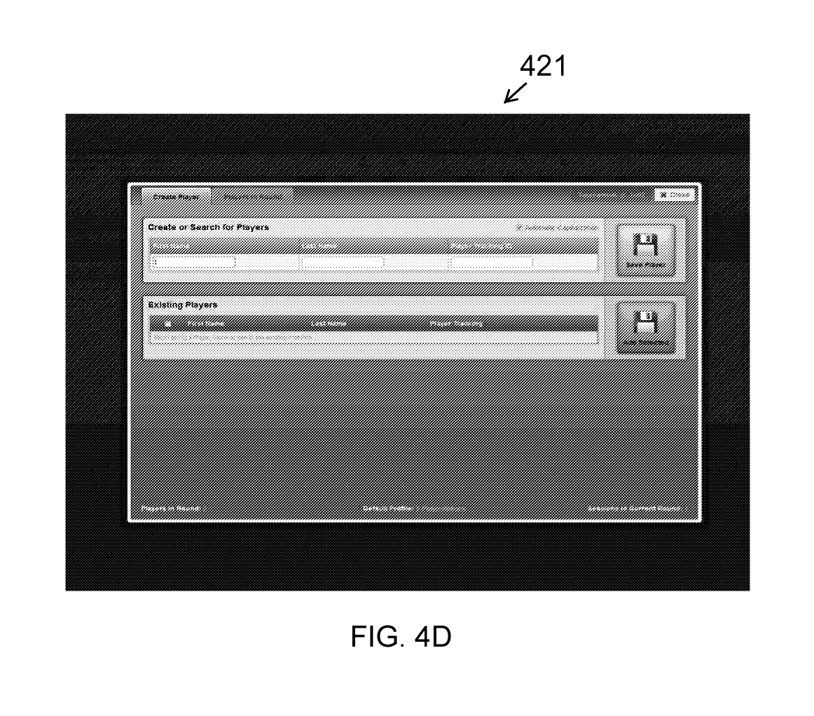

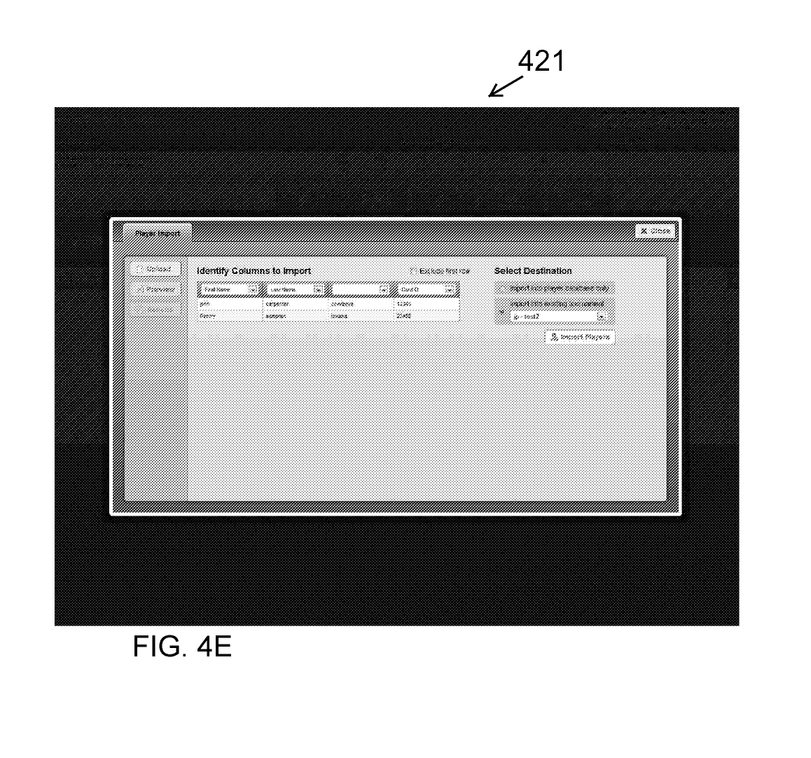

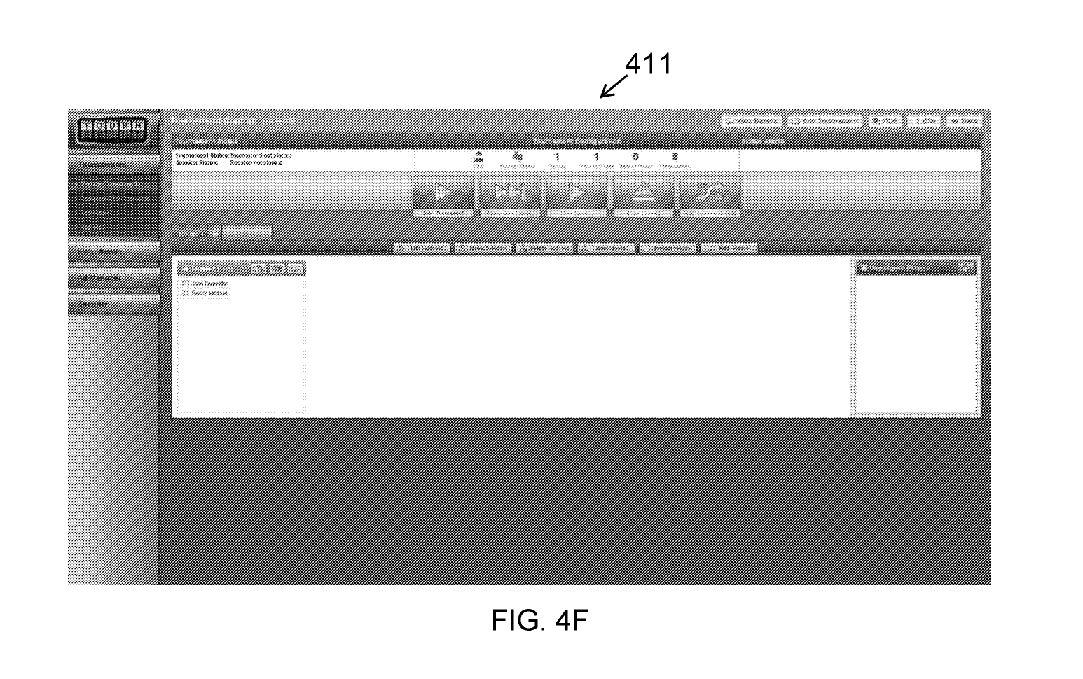

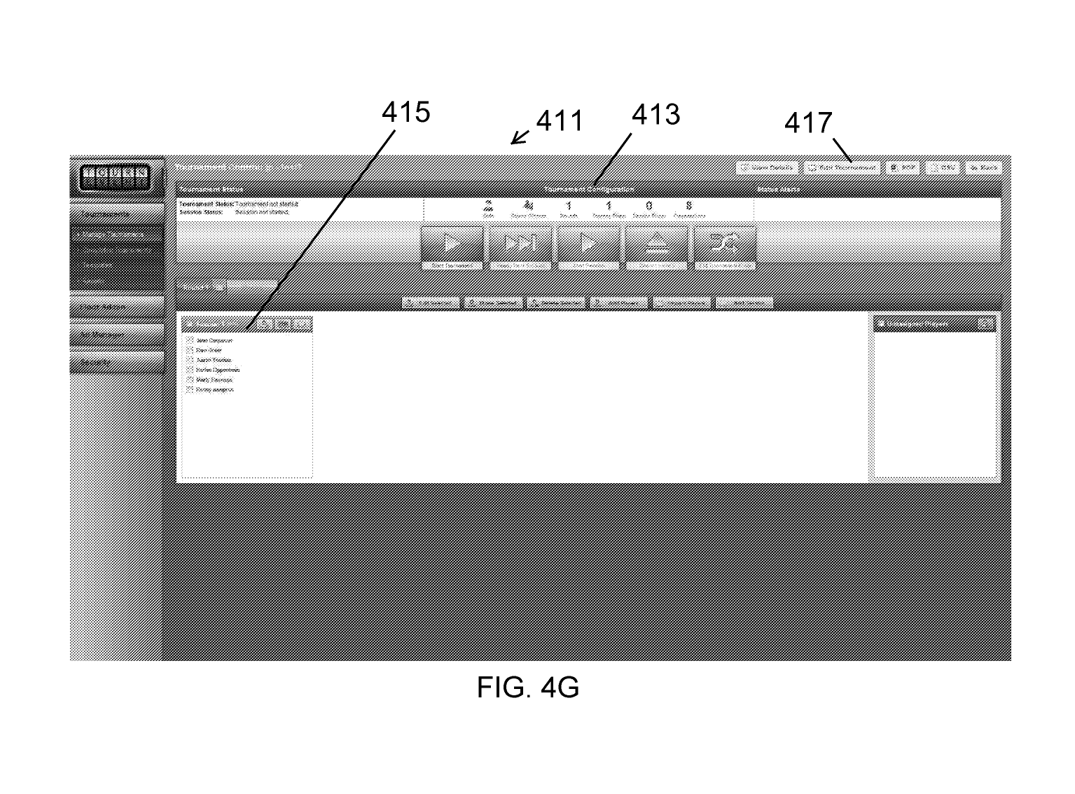

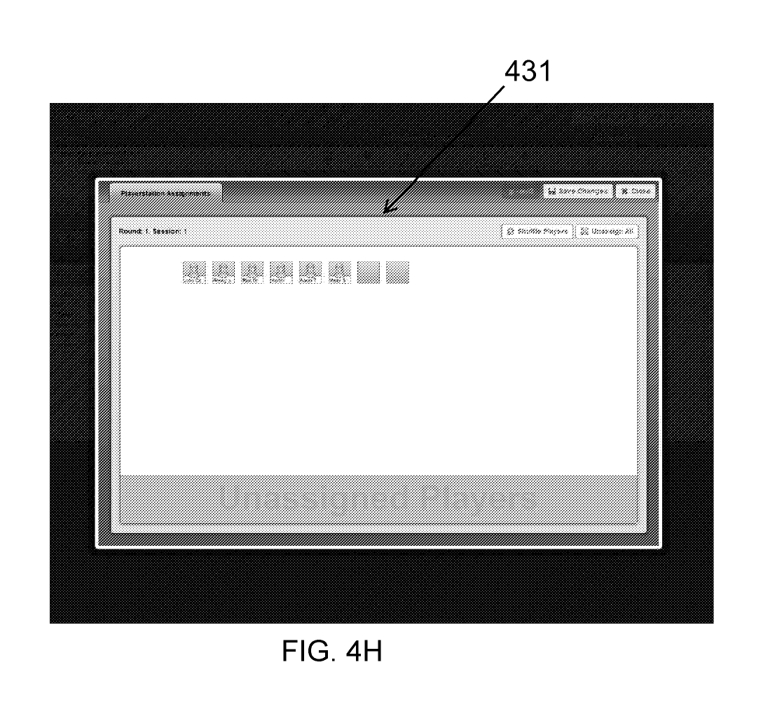

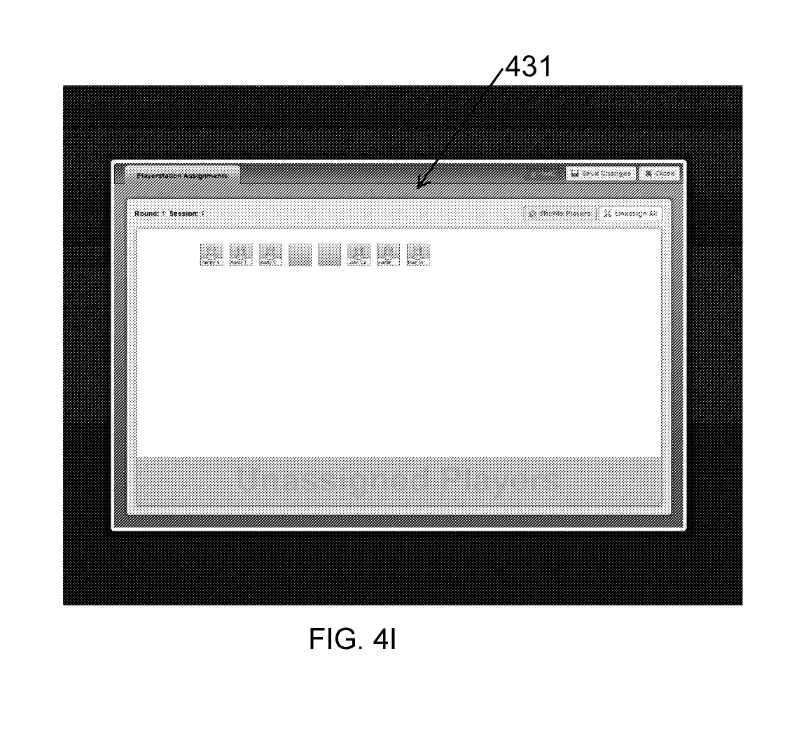

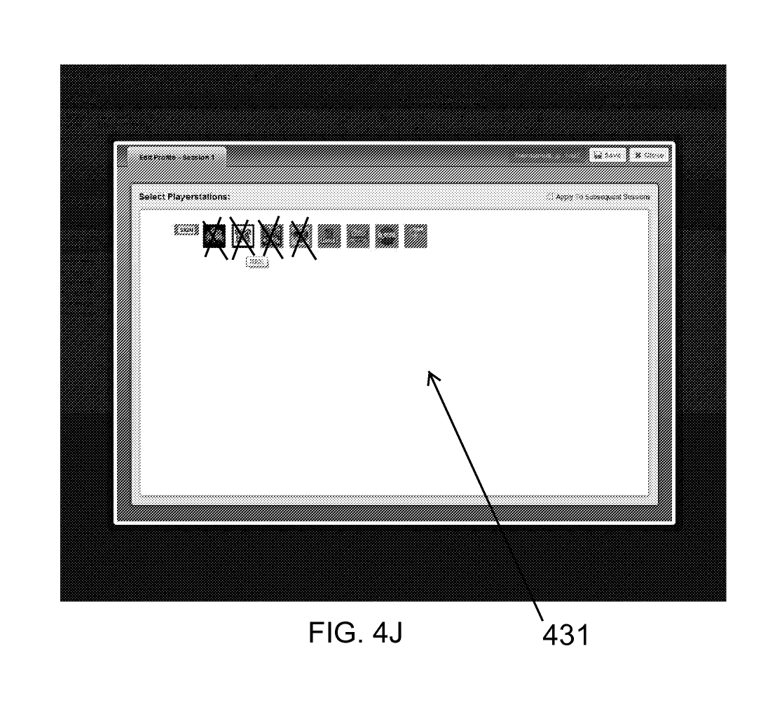

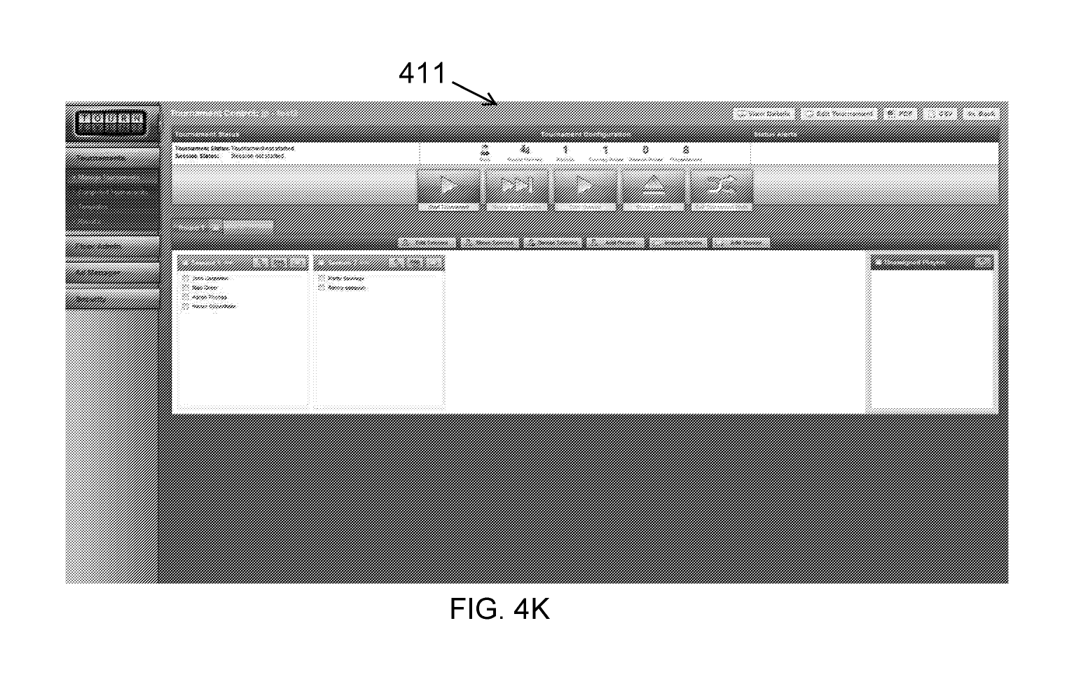

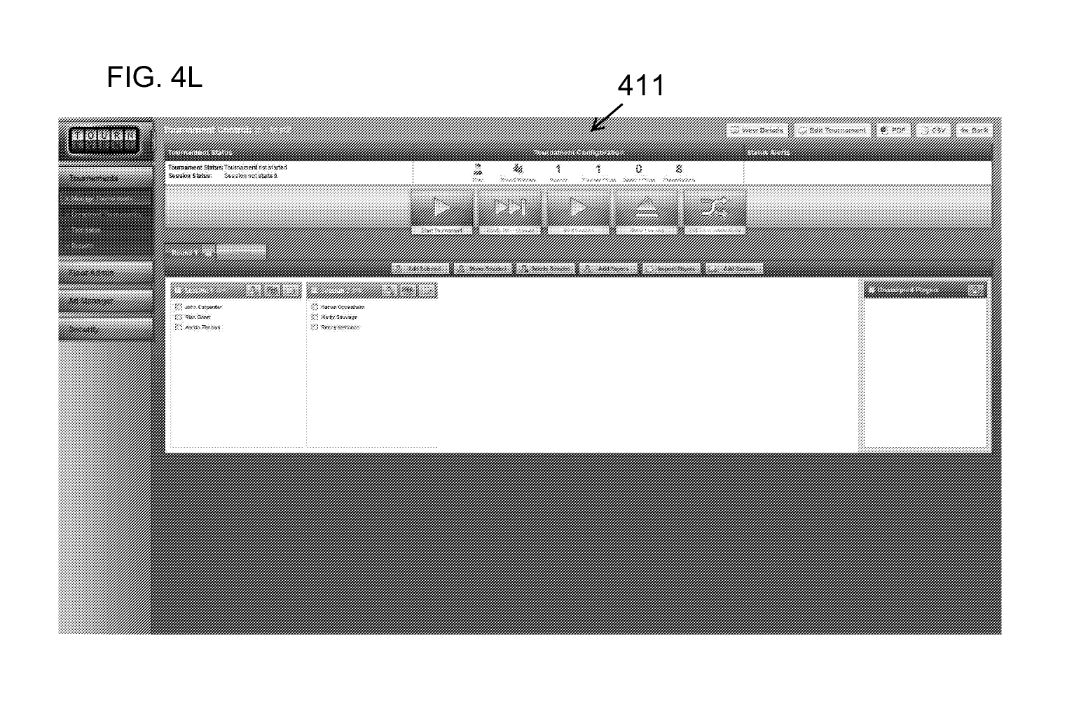

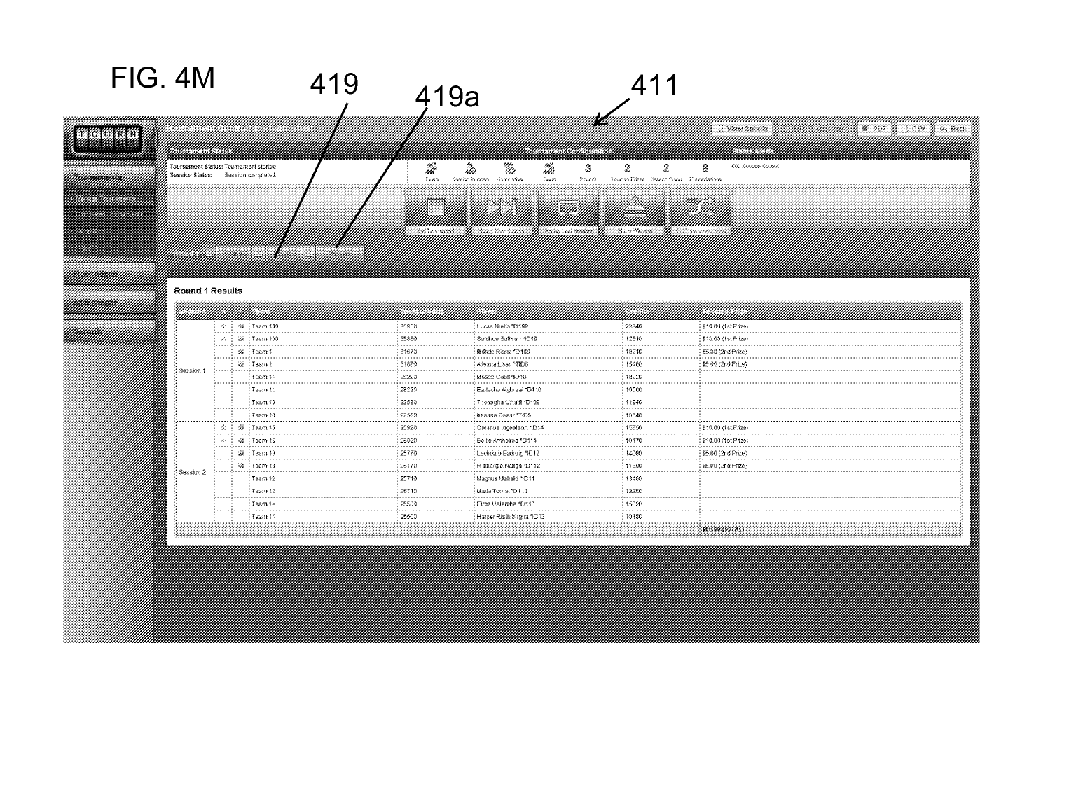

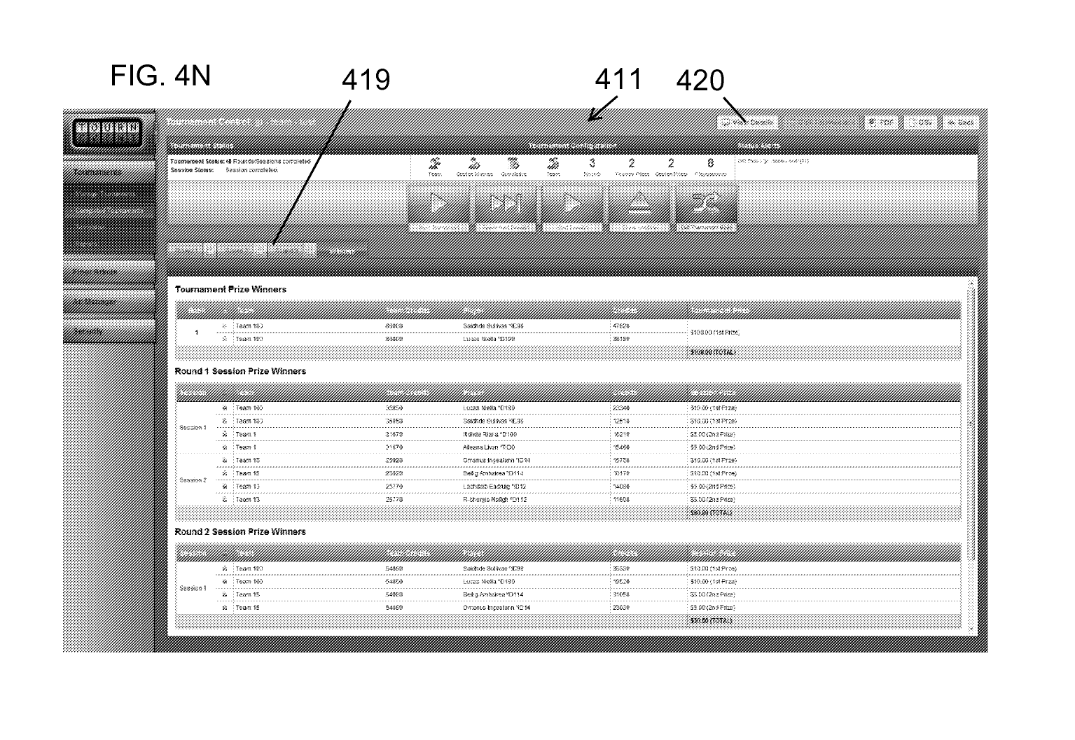

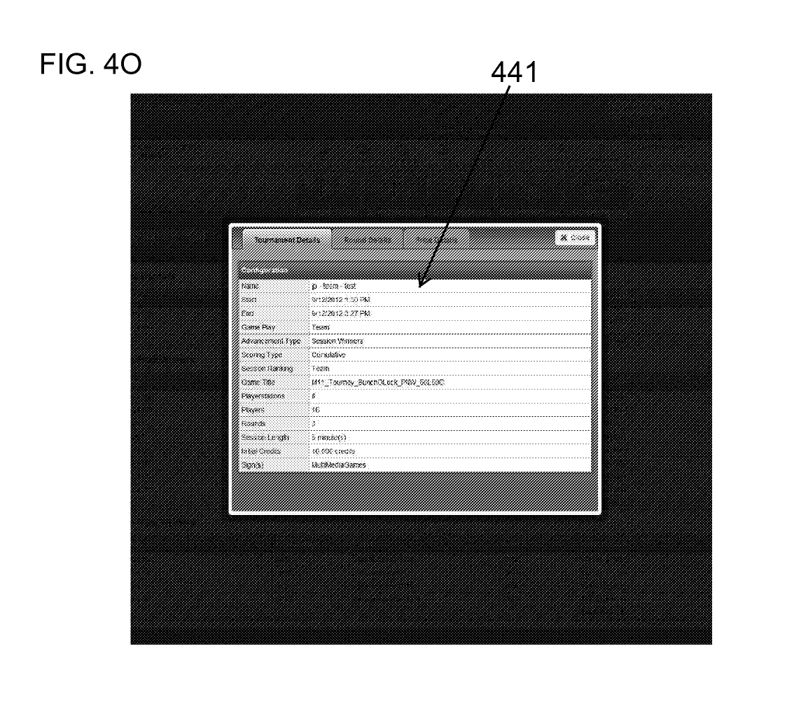

Once saved, the tournament may automatically be placed into the “Pending Tournaments” listing as displayed on tournaments screen 200 in FIG. 2 and/or “Tournament Control” panel 411 in FIG. 4C (described below), either screen enabling the user to import (sign up, enroll or add) players and initiate the tournament. For example, from tournaments screen 200 in FIG. 2, the user may select the “Import Players” button 215, which may cause player import screen 400 to be displayed as shown by example in FIG. 4A.

FIG. 4A shows an example player import screen 400. Player import screen 400 includes an “Upload” button 401 which when selected enables the user to access one or more player database files (e.g. *.csv files) containing Player Names, Player Account Number (tracking ID), Card ID, and Team Name (if the file has been set up with teams). After selecting one of the files, the data may be listed on imported player list 403 with a separate row 403a dedicated to each player. Headers for each column of information may include First Name, Last Name, Player Tracking ID, Card ID, and Team Name (if applicable). Player import screen 400 also includes a “Select Destination” display 405. The controls of this “Select Destination” display 405 allow the data to be imported to a tournament player database, such as if the file has been copied from a flash or external server memory (e.g. player database stored by a player tracking server on an accessible memory), or, the data may be imported directly into an existing tournament. Once the player has selected the destination and clicked the “Import Players” button 405a of “Select Destination” display 405, then player import screen 400 may change to display the results of the import operation indicating the location where the player database was imported and whether any errors occurred in the import as shown in FIG. 4B for example.

Once player import screen 400 is closed, the display may then show the screen from which the user initiated the import, either tournaments screen 200 or tournament control screen 411. In the case of reverting to tournaments screen 200, the user may then select the respective control button for a given tournament and cause the tournament control screen 411 of FIG. 4C to be displayed. Where the player data is imported directly into an existing tournament using the appropriate control of the “Select Destination” display of FIG. 4A, tournament control screen 411 shows the imported player database 405 from FIG. 4A populating each of the sessions required to accommodate the number of players in the imported database.

The tournament server may store multiple player database files including a master database file. One or more of the player database files may be pre-selected tournament players; for example, ABC company may have a group of players to play in a company tournament, the ABC.csv file is provided to the tournament operator (user), who then may upload the file to a tournament server accessible memory, and select one of the Import Players button to access player import screen 400 and import the players directly to a selected tournament.

Alternatively, players may be enrolled in a selected tournament by the user selecting an “Add Players” button 412 on the tournament control screen 411 shown in FIG. 4C. Once selected, a create player screen 421 as shown on FIG. 4D may be displayed and enable the enrollment of one or more players by inserting or swiping each player's player card through a card reader, such as card reader 111 at user console 102 shown in FIG. 2. For example, when a player card is swiped through card reader 111, the player information may be read from the card and the tournament processor may search the tournament database file or files for information that matches the player and if found, the information may be populated on create player screen 421. If not found, the player information may be typed in manually into the respective fields and the player information may both be saved and imported into the selected tournament. Multiple players may be enrolled both by card reader 111 and manually until a group is complete (e.g. FIG. 4E, and when saved, populated to tournament control screen 411 as in FIG. 4F) or the players may be enrolled and saved individually into the selected tournament. The enrollment steps may be initiated multiple times until a tournament field is developed as shown on tournament control screen 411 of FIG. 4G wherein a tournament field of six players is created.

Referring to FIG. 4G, the tournament configuration may, for example, provide for a solo tournament with round winners, one round, one tournament prize, zero session prizes and eight playerstations, which may be shown in a “Tournament Configuration” field 413. In the example case, in the event that there are only six players, then two play stations may be released if it is desired to simply have one session. In the “Session” field 415, a selectable playerstation icon may enable the user to access a player assignments screen 431 shown in FIG. 4H, which may display the players assigned to respective of the available playerstations as shown in FIG. 41. Those playerstations which are not being used may be blank. By clicking on a “Shuffle Players” button, the players' playerstation assignments may be shuffled amongst the available playerstations. If the user wishes to release the additional playerstations, the user may save the changes to the player playerstation assignments and return to the tournament control screen 411 where the user may select the “Edit Tournament” button 417 (FIG. 4G) to return to the tournament edit screen 301 and edit the number of playerstations by selecting the “Playerstations” element 347 as shown in FIG. 3H. In the example shown in FIG. 4J, four playerstations are de-selected and once saved, the screen is replaced by the tournament control screen 411 of FIG. 4K and the players are automatically shifted to two sessions to accommodate use of only four playerstations. In the example, the first session now has four players and the second session two players. The sessions may be evened out by simply selecting one of the players from the first session and moving the player to the second session as shown in FIG. 4L.

Once a round has been completed, the user may select one of the selectable “Round” buttons 419 as shown in FIG. 4M to display results of the selected round including the names of the team (if applicable), the player names, scores, session prizes (if any), and an indicator whether the team (or player) advances to a next round (if any). In the example of FIG. 4M, the tournament is a team play tournament with three rounds, two session prizes, two tournament prizes, and eight playerstations. Two teams are shown to receive session prizes and one team is shown to advance from each session.

Once the tournament has been completed, the user may select any of the selectable “Round” buttons 419 including a “Winners” button 419a which when selected may display the “Tournament Prize Winners” and “Session Prize Winners” as shown in FIG. 4N. Lastly, the user may see the tournament details by selecting the “View Details” button 420 and display a tournament details screen 441 as shown in FIG. 4O which may include tournament name, start and end time, initial credits for players to begin the tournament, signage, and the tournament parameters.

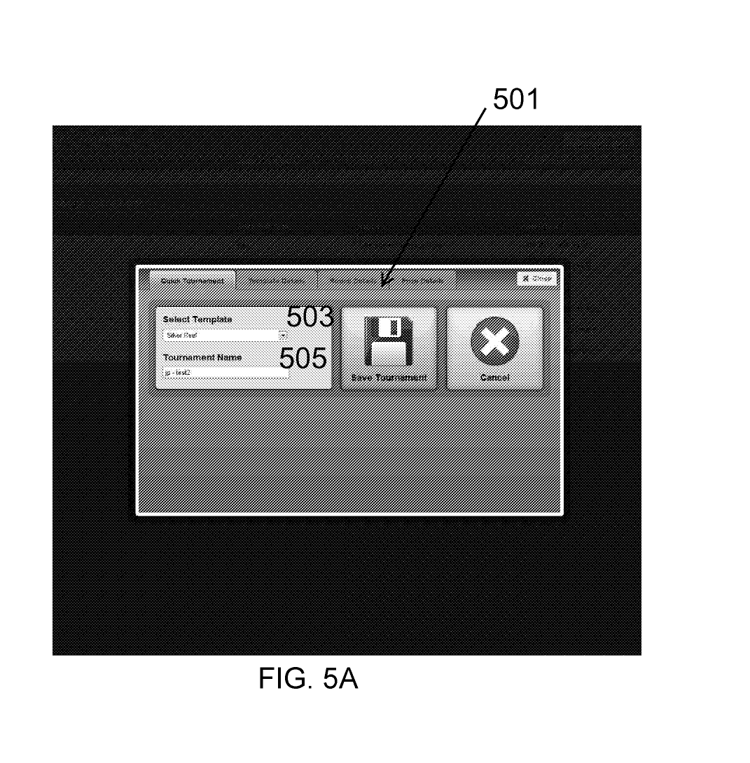

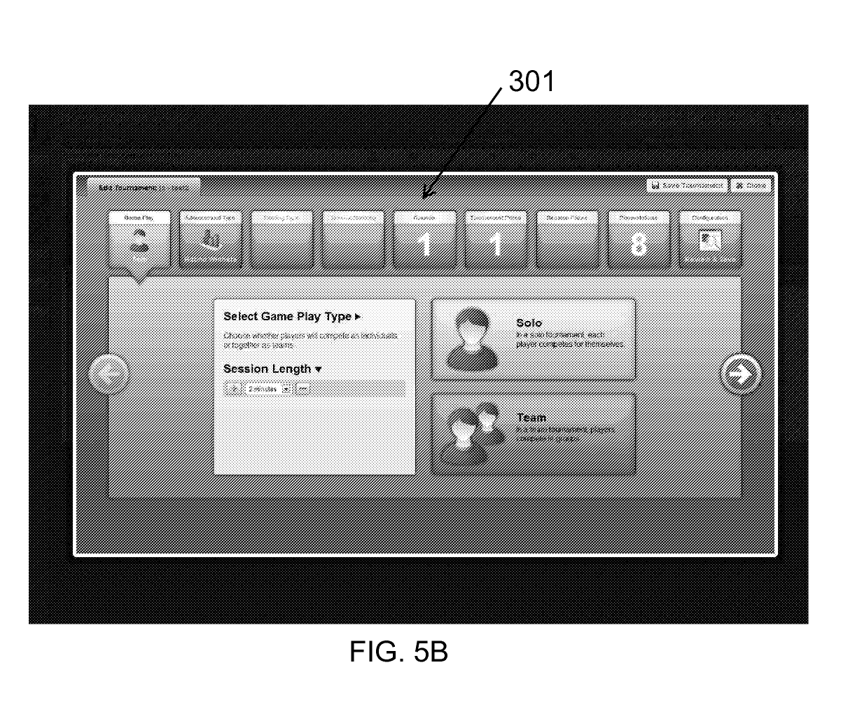

Referring to FIG. 5A, example quick tournament screen 501 is shown as may be obtained by the user selecting the “Quick Tournament” 219 selectable field shown in FIG. 2. The quick tournament screen 501 may provide a “Select Template” field 503 with a drop down menu of stored tournament templates and a “Tournament Name” field 505 with an area for the user to input a tournament name. Additionally, quick tournament screen 501 may include a “Save Tournament” button and a “Cancel” button with which to respectively save the new tournament using the selected template or to cancel the tournament. Once saved, the edit tournament screen 301 may be displayed as shown in FIG. 5B to enable the user to make any modifications to the new tournament from the template settings.

While the example description and figures have been directed to a single bank of eight playerstations, the tournament server may connect and control multiple banks including multiple overhead displays simultaneously utilizing the tournament program. The number of banks and overhead displays essentially being limited to the number of physical connections that may be made to operate the tournament and control the games simultaneously on each of the respective playerstations.

Referring generally to the forgoing description and to the following claims, as used herein the terms “comprising,” “including,” “carrying,” “having,” “containing,” “involving,” and the like are to be understood to be open-ended, that is, to mean including but not limited to. Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above described example embodiments are intended to illustrate the principles of the invention, but not to limit the scope of the invention. Various other embodiments and modifications to these preferred embodiments may be made by those skilled in the art without departing from the scope of the present invention.

1. A method of operating a tournament gaming system, the method including:
(a) displaying a menu of tournament parameters selectable by an operator to program a tournament, the menu of tournament parameters being displayed at a display device of a user console of a tournament gaming system under the control of one or more processors included in the tournament gaming system;
(b) responsive to an import request received through the user console of the tournament gaming system, saving a set of tournament player information in a tournament database under the control of the one or more processors;
(c) responsive to data read from a player card through a player card reader included in the tournament gaming system, searching the tournament database for stored data matching the data read from the player card, the tournament database being searched under the control of the one or more processors included in the tournament gaming system;
(d) responsive to finding stored data corresponding to the data read from the player card, and under the control of the one or more processors included in the tournament gaming system, enrolling a player associated with that player card into the tournament; and
(e) responsive to a tournament play request, and under control of the one or more processors included in the tournament gaming system, initiating play in the tournament with the one or more players.

2. The method of claim 1 further including, responsive to an upload request prior to receiving the import request, displaying the set of tournament player information at the display device of the user console under control of the one or more processors.

3. The method of claim 2 further including, under control of the one or more processors, displaying at the display device of the user console a destination selection control including an option to import the set of tournament player information into the tournament database only and an option to import the set of tournament player information into a previously defined tournament for the tournament gaming system, the destination selection control being displayed along with the set of tournament player information.

4. The method of claim 3 further including, responsive to the import request and a selection of the option to import the set of tournament player information into the previously defined tournament, displaying players from the set of tournament player information in a tournament control interface at the display device of the user console under control of the one or more processors, the players from the set of tournament player information being displayed in a number of tournament sessions generated by the tournament gaming system to accommodate the number of players included in the set of tournament player information.

5. The method of claim 1 wherein the set of tournament player information includes a team identifier associated with data for each respective tournament player identified in the set of tournament player information.

6. The method of claim 1 wherein the set of tournament player information to be saved is read from a data storage medium inserted in a data interface device at the user console.

7. The method of claim 1 wherein the tournament play request is received through the user console of the tournament gaming system.

8. A tournament gaming system including:
(a) a number of gaming machines alternatively operable in a tournament game mode and an individual play mode;
(b) a user console including a display device and a card reader; and
(c) a control center operatively connected for communications to and from the user console and each of the number of gaming machines, the control center including at least one memory device and at least one processor, and the at least one memory device storing instructions executable by the at least one processor to:
(i) cause the display device to display a menu of tournament parameters selectable by an operator to program a tournament;
(ii) responsive to an import request received through the user console, saving a set of tournament player information in a tournament database;
(iii) responsive to data read from a player card through the player card reader, searching the tournament database for stored data matching the data read from the player card;
(iv) responsive to finding stored data corresponding to the data read from the player card, enrolling a player associated with that player card into the tournament; and
(v) responsive to a tournament play request, initiating play in the tournament through one or more of the number of gaming machines.

9. The tournament gaming system of claim 8 wherein the at least one memory device stores instructions executable by the at least one processor to, responsive to an upload request prior to receiving the import request, displaying the set of tournament player information at the display device of the user console.

10. The tournament gaming system of claim 9 wherein the at least one memory device stores instructions executable by the at least one processor to cause the user console display device to display along with the set of tournament player information a destination selection control including an option to import the set of tournament player information into the tournament database only and an option to import the set of tournament player information into a previously defined tournament for the tournament gaming system.

11. The tournament gaming system of claim 10 wherein the at least one memory device stores instructions executable by the at least one processor to, responsive to the import request and a selection of the option to import the set of tournament player information into the previously defined tournament, causing the user console display device to display players from the set of tournament player information in a tournament control interface, the players from the set of tournament player information being displayed in a number of tournament sessions generated by the tournament gaming system to accommodate the number of players included in the set of tournament player information.

12. The tournament gaming system of claim 8 wherein the set of tournament player information includes a team identifier associated with data for each respective tournament player identified in the set of tournament player information.

13. The tournament gaming system of claim 8 wherein the at least one memory device stores instructions executable by the at least one processor to read the set of tournament player information from a data storage medium inserted in a data interface device at the user console.

14. The tournament gaming system of claim 8 wherein the tournament play request is received through the user console of the tournament gaming system.

15. A method of operating a tournament gaming system, the method including:
(a) displaying a menu of tournament parameters selectable by an operator to program a tournament, the menu of tournament parameters being displayed at a display device of a user console of a tournament gaming system under the control of one or more processors included in the tournament gaming system;
(b) responsive to an import request received through the user console of the tournament gaming system, saving a set of tournament player information in a tournament database under the control of the one or more processors, the set of tournament player information identifying one or more tournament players; and
(c) responsive to a tournament play request, and under control of the one or more processors included in the tournament gaming system, initiating play in the tournament with one or more players identified in the set of tournament player information.

16. The method of claim 15 further including, responsive to an upload request prior to receiving the import request, displaying the set of tournament player information at the display device of the user console under control of the one or more processors.

17. The method of claim 16 further including, under control of the one or more processors, displaying at the display device of the user console a destination selection control including an option to import the set of tournament player information into the tournament database only and an option to import the set of tournament player information into a previously defined tournament for the tournament gaming system, the destination selection control being displayed along with the set of tournament player information.

18. The method of claim 17 further including, responsive to the import request and a selection of the option to import the set of tournament player information into the previously defined tournament, displaying players from the set of tournament player information in a tournament control interface at the display device of the user console under control of the one or more processors, the players from the set of tournament player information being displayed in a number of tournament sessions generated by the tournament gaming system to accommodate the number of players included in the set of tournament player information.

19. The method of claim 15 wherein the set of tournament player information includes a team identifier associated with data for each respective tournament player identified in the set of tournament player information.

20. The method of claim 15 wherein the set of tournament player information to be saved is read from a data storage medium inserted in a data interface device at the user console.
